(19) United States
(12) Patent Application Publication
(10) Pub. No.: US 2013/0228497 A1
(43) Pub. Date: Sep. 5, 2013

(54) SYSTEMS AND METHODS FOR FILTERING METALS FROM FLUIDS

(71) Applicant: Ricky D. Watts, Ponca City, OK (US)

(72) Inventor: Ricky D. Watts, Ponca City, OK (US)

(73) Assignee: BAKER HUGHES INCORPORATED, HOUSTON, TX (US)

(21) Appl. No.: 13/409,649

(22) Filed: Mar. 1, 2012

(51) Int. Cl. C10G 53/02; B01D 37/00; B03C 1/30

(52) U.S. Cl. 208/251 R; 196/46.1; 210/695; 210/223; 210/182; 210/195.1

(57) ABSTRACT

A method of processing a liquid having magnetic particles includes increasing a magnetic particle content in at least a portion of the liquid; forming an effluent using the portion of the liquid that has the increased magnetic particle content; and filtering the effluent using a magnetic field.

### CROSS-REFERENCE TO RELATED APPLICATIONS

1. Field of the Disclosure

This disclosure is directed to the filtering fluids having metals. More specifically, the present disclosure relates to the removal of metals from crude oils.

2. Background of the Disclosure

It is common to use relatively heavy crudes and petroleum residues as the feedstock for various operations. This feedstock may contain relatively high contents of contaminating metals and sulfur. The high metal content of heavy crude oils and petroleum residues may be undesirable for a variety of reasons, such as the detrimental effects of these metals on various catalysts used in various petroleum treatment processes.

The present disclosure addresses the need to remove metals from crude oils or other fluids.

### SUMMARY OF THE DISCLOSURE

In aspects, the present disclosure provides a method of processing crude oil. The method may include increasing an iron content in the crude oil to a specified value using a desalter; drawing an effluent from the desalter, the effluent being crude oil having an increased iron content; and reducing the iron content of the effluent using a magnetic field in the filter.

In aspects, the present disclosure also provides a system for processing crude oil. The system may include a desalter; a line drawing a fluid effluent from the desalter; and a magnetic filter configured to apply a magnetic field to the fluid effluent.

In aspects, the present disclosure further provides a method of processing a liquid having magnetic particles. The method may include increasing a magnetic particle content in at least a portion of the liquid; forming an effluent using the portion of the liquid that has the increased magnetic particle content; and filtering the effluent using a magnetic field.

Examples of certain features of the disclosure have been summarized (albeit rather broadly) in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE FIGURES

For detailed understanding of the present disclosure, reference should be made to the following detailed description, taken in conjunction with the accompanying drawing:

FIG. 1 schematically illustrates a magnetic filtering system for treating crude oil or other metal-containing fluids according to one embodiment of the present disclosure;

### DETAILED DESCRIPTION OF THE DISCLOSURE

The present disclosure relates to methods and devices for removing magnetic particles from liquids. While the present disclosure may be applied to a variety of applications, for brevity, the present disclosure will be discussed in the context of removing metals from crude oil.

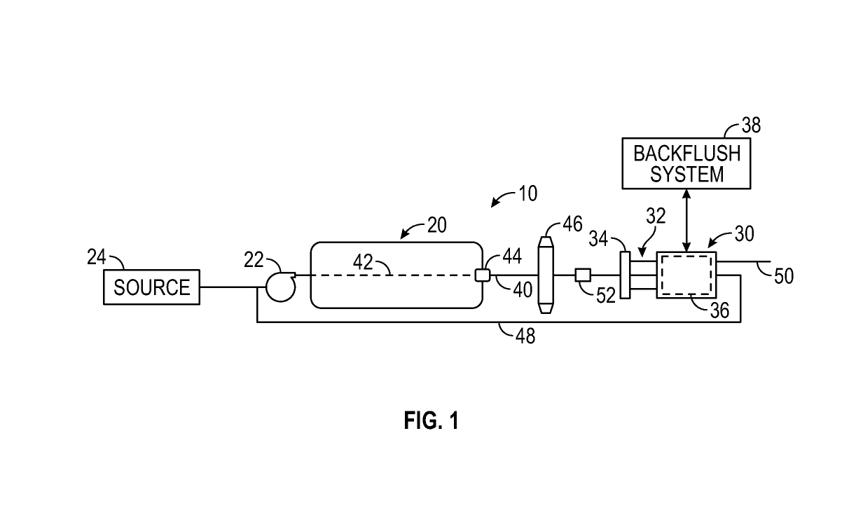

Referring now to FIG. 1, there is shown one embodiment of a filtration system 10 for reducing the amount of magnetic material in a liquid. For convenience, crude oil will be used as an illustrative liquid. The system 10 may include a desalter 20 and a filter 30. The desalter 20 may be a conventional device adapted to remove contaminants such as salts (e.g., calcium, sodium and magnesium chlorides), suspended solids, and water-soluble trace metals in the crude oil. The desalter 20 may use chemical, electrostatic separation, or any other separation technique to remove the contaminants from the crude oil. A pump 22 or other suitable fluid mover may be used to flow crude oil into the desalter 20.

The filter 30 applies a magnetic field to a fluid effluent from the desalter 20 to remove magnetic particles such as ferrites (e.g., iron). In one embodiment, the filter 30 includes a plurality of parallel flow lines 32 fed via a manifold 34. The manifold 34 can hydraulically isolate one or more of the flow lines 32. The flow lines 32 may be tubulars, channels, plates, or other known fluid conduits and may incorporate drums. Each of the parallel flow lines 32 are positioned such that the effluent passes through a magnetic field generated by an electrically charged media 36. The media 36 may include electromagnetic elements that generate the magnetic field when energized with electrical energy. For example, the media 36 may include wire coils and use direct current to generate a magnetic field. The magnetic particles in the crude oil will be attracted to the energized media and held in place until the media is de-energized. Illustrative magnetic filters include, but are not limited to, T-Trap magnetic filters and rotating wet drum magnetic filters. In other embodiments, permanent magnetic separators that use permanent magnet material may be used.

As the magnetic particles accumulate on the electrically charged media 36, the effectiveness of the filtering process may diminish. Thus, periodically, one or more of the flow lines 32 may be sealed off using the manifold 34 and back-flushed using a suitable cleaning fluid to remove the accumulated particles. During the back-flush process, the unsealed flow lines 32 continue to operate and filter the crude oil without interruption. A suitable back-flushing system 38 may be used to circulate and/or purge the cleaning fluid In some embodiments, the back-flush fluid may be subjected to further processing and used; e.g., the back-flush fluid may be processed to a slurry that may be burned in cement kilns or discharged to a waste plant for processing and disposal.

In one embodiment, a line 40 directs the fluid effluent from the desalter 20 to the filter 30. An oil and brine typically mix to form a “rag” layer 42 at an interface between two phases, here water and oil. In one arrangement, a port 44 of the line 40 may be positioned at the rag layer 42 in the desalter 20. Because the rag layer 42 may be dynamic, the port 44 may be configured to float or otherwise orient itself to remain in fluid communication with the rag layer 42. That is, as the rag layer 42 rises or falls in the desalter 20, the port 44, or a component of the port 44, may also move to draw in the rag layer 42.

In some embodiments, a cooler 46 may be used to cool the effluent fluid in the line 40. Many conventional desalters 20 add significant thermal energy into the crude oil during the desalting process. Typically, a magnetic flux decreases with temperature. Therefore, the cooler 46 may be employed to reduce the temperature of the effluent fluid to a desired value. In some embodiment, the desired value may be approximately an ambient temperature. This may be desirable since the magnetic flux generated by the electromagnetic media 36 may not have to be intensified to adequately filter the rag layer or the residuum stream. The cooler 46 may be of a known type that actively reduces the thermal energy in a liquid stream; e.g., heat exchangers, chiller water pipes, etc.

In one arrangement, the filter 30 returns the filtered crude oil to a suction side 24 of the pump 22 via a line 48. Thus, the pump 22 may be used to generate the pressure differential to flow the filtered crude oil from the filter 20. This may reduce or eliminate the need to use a separate pump for pumping fluid from the filter 30. In other embodiments, the filter 30 returns the filtered crude oil to desalter 20 via a line (not shown) that includes a dedicated pump or other fluid mover.

In one mode of use, a crude oil is supplied to the desalter 20. As the crude oil is treated in the desalter 20, the port 44 draws the rag layer 42 out of the desalter 20 to form a fluid effluent that mostly consists of the rag layer 42. The effluent is cooled by the cooler 46 and sent to the manifold 34. The manifold 34 directs the effluent to one or more of the lines 32. As the effluent passes through the magnetic field generated by the electromagnetic media 36, magnetic particles (e.g., iron) are attracted out of the effluent in the line(s) 32 and settle or otherwise layer the interior surfaces of the line(s) 32. Thereafter, the filtered effluent is returned to the desalter 20 via line 48.

It should be appreciated that cycling magnetically filtered effluent into the desalter 20 gradually reduces the overall iron content of the crude oil in the desalter 20. After a desired iron content has been reached in the desalter 20, a residuum stream from the desalter 20 may be drawn for further processing (e.g., phase separation).

In another mode of use, the crude oil in the desalter 20 is processed to achieve a desired iron concentration. Thereafter, the residuum stream from the desalter 20 is sent to the filter 30 for filtering. The residuum stream is not returned to the desalter 20.

For back-flush operations, some of the lines 32 are sealed off and placed into fluid communication with the back-flush system 38. The unsealed lines 32 continue to flow effluent through the filter 30. A suitable cleaning liquid is circulated through the sealed lines 32 to dislodge and entrain the settled magnetic particles. In some embodiments, a portion or section of the electromagnetic media 36 that applied a magnetic field to the lines 32 being back-flushed may be de-activated to release the accumulated particles. The cleaning liquid and entrained magnetic particles are then disposed of or processed further. It should be appreciated that the selectively back-flush capability allows the effluent from the desalter 20 to be continually magnetically filtered.

It should be appreciated that the present disclosure may be susceptible to numerous variants. Illustrative variants are described below.

In some variants, a surface active reducing agent (surfactant) may be used to increase the efficiency of the filter 30. For example, a surfactant supply 52 may be used to introduce one or more surfactants in the desalter effluent in line 40. A suitable surfactant may reduce the surface tension on the solids (e.g., metals) bound in oil/water emulsions making up the rag layer 42. Suitable surfactants include, but are not limited to, anionic, nonionic, cationic, amphoteric, zwitterionic, extended surfactants and blends thereof. Still other suitable nonionic surfactants include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both.

In some variants, some or all of the filtered crude oil may be conveyed via the line 50 to a separate location for further processing. For example, the line 50 may convey the filtered effluent to a separator (not shown) for phase separation or an oil recovery unit (ORU). For example, a centrifuge may be used to separate oil, water, and solids. The separated phases may be disposed of or processed further in devices such as an oil recover. Thus, the filtered crude oil does not necessarily have to be returned to the desalter 20.

In some variants, the filter 30 may receive the residuum stream from the desalter 20. That is, the desalter 20 processes the crude oil to a specified condition or parameter. Once the crude oil is processed to a specified condition, this processed crude oil is passed to the filter 30 at a flow rate low enough that the magnetic filtering can effectively remove the entrained magnetic particles. Thus, the filtered crude oil is not cycled back into the desalter 20.

Some variants may also use additives or processing techniques to decrease a viscosity of the effluent entering the filter 30. Maintaining a relatively low effluent viscosity may allow a more efficient migration of the magnetic particles through the effluent.

While the foregoing disclosure is directed to the preferred embodiments of the disclosure, various modifications will be apparent to those skilled in the art. It is intended that all variations within the scope of the appended claims be embraced by the foregoing disclosure.

We claim:

1. A method of processing crude oil, comprising:
increasing an iron content in the crude oil to a specified value using a desalter;
drawing an effluent from the desalter, the effluent being crude oil having an increased iron content; and
reducing the iron content of the effluent using a magnetic field in a filter.

2. The method of claim 1, further comprising cooling the effluent using a cooler.

3. The method of claim 1, further comprising returning the effluent to the desalter.

4. The method of claim 3, further comprising drawing a residuum stream from the desalter.

5. The method of claim 1, further comprising processing the reduced iron effluent to separate an oil from a water using a separator.

6. The method of claim 1, further comprising flushing the filter to remove iron filtered from the effluent.

7. The method of claim 1, wherein the effluent is drawn substantially from a rag layer in the desalter.

8. A system for processing crude oil, comprising:
a desalter;
a line drawing a fluid effluent from the desalter; and
a magnetic filter configured to apply a magnetic field to the fluid effluent.

9. The system of claim 8, further comprising a cooler configured to reduce a temperature of the fluid effluent.

10. The system of claim 8, further comprising a return line returning the effluent from the magnetic filter to the desalter.

11. The system of claim 8, further comprising a separator receiving the fluid effluent from the magnetic filter, the separator being configured to separate oil from water.

12. The system of claim 8, further comprising a back-flush system in fluid communication with the magnetic filter, the back-flush system being configured to remove filtered iron from the magnetic filter.

13. The system of claim 8, wherein the line is positioned to draw substantially from a rag layer from the desalter.

14. A method of processing a liquid having magnetic particles, comprising:
increasing a magnetic particle content in at least a portion of the liquid;
forming an effluent using the portion of the liquid that has the increased magnetic particle content; and
filtering the effluent using a magnetic field.

15. The method of claim 14, further comprising cooling the effluent using a cooler.

16. The method of claim 14, further comprising:
receiving the fluid in a container, wherein the magnetic particle content is increased in the container; and
returning the effluent to the container.

17. The method of claim 1, wherein the effluent is drawn substantially from a mixed phase layer associated with the liquid.
